(19) United States
(12) Patent Application Publication
(10) Pub. No.: US 2012/0304247 A1
(43) Pub. Date: Nov. 29, 2012

(54) SYSTEM AND PROCESS FOR HIERARCHICAL TAGGING WITH PERMISSIONS

(76) Inventors: JOHN BADGER, Portola Valley, CA (US); Muralidhara Kreshavamurthy, Bangalore (IN); Vedavathi Hanumanthaiah, Bangalore (IN); Mahesh Viraktamath, Hubli (IN)

(21) Appl. No.: 13/481,029

(22) Filed: May 25, 2012

Related U.S. Application Data
(60) Provisional application No. 61/519,633, filed on May 25, 2011.

(51) Int. Cl. G06F 17/30; G06F 21/00

(52) U.S. Cl. 726/1; 707/783; 707/E17.01

(57) ABSTRACT

The invention provides a file sharing system and process for hierarchical tagging with permissions in computer network-based file storage and sharing systems. The file sharing system includes a hierarchical list of tags, a plurality of files, a hierarchical tag management facility and a tag permissions facility. Each of the plurality of files is tagged by one or more tags in the hierarchical list of tags. The hierarchical tag management facility is used to create and manage the hierarchical list of tags. The tag permissions facility is activated when an administrator selects one or more tag(s). The administrator is a user having rights to facilities to configure the file sharing system. The tags permissions facility is used to change permissions for one or more users or groups of users to access a plurality of files tagged with the selected tag(s).

This application claims priority to the U.S. provisional patent application Ser. No. 61/519,633, filed on 25 of May 2011, the contents of which are incorporated by reference herein.

### FIELD OF THE INVENTION

This invention generally relates to information sharing and management technology. More particularly, the invention relates to a system and process for hierarchical tagging with permissions in computer network-based file storage and sharing systems.

### BACKGROUND OF THE INVENTION

There are two known methods for organizing files in network-based file storage and sharing systems: folders, also known as directories, and tags, also known as metadata, keywords or labels. Tags can be in some cases hierarchical. Faceted tags are also common. In many cases, both folders and tags are used together in the same system.

### Folders

A folder is a virtual container within a digital file system, in which groups of computer files and other folders can be kept and organized. Files are kept organized by storing related files in the same folder. Folders are organized in a hierarchical structure. The topmost folder in the hierarchy can also be referred to as the root. A folder contained inside another folder is called a subfolder or subdirectory or child of that folder. Together, the folders form a hierarchy or a tree structure.

A file can be in exactly one folder. In some operating systems, a method is provided for creating a shortcut, also known as a symbolic link or alias, which is a small file containing a reference to storage location of the original. The shortcut provides for a method to place a virtual copy of the file in multiple locations within the folder hierarchy. Only one of the locations has the original file, and the user is responsible for keeping track of which of those locations contains the original. If the original file is deleted, the user will receive an error when attempting to access one of the shortcuts that refer to the deleted file.

In many cases, folders have permissions that grant or deny individual users, or named groups of users, certain rights with respect to the folder and its contents, such as permission to view, modify or otherwise interact with the folder and/or the folder's contents, i.e. files and/or subfolders. An administrator user can set the permissions on a per-folder basis. Typically the files contained in a folder inherit that folder's permissions. In certain implementations, however, the files can have separate permissions.

It is normally not allowed to have multiple files with the same name in the same folder, so when a user attempts to place a file in a folder that already has a file of the same name, the user is prompted to determine if the existing file should be overwritten with the new file, if the name of the new file should be changed, or if the operation should be cancelled. This method is instrumental in preventing confusion that could arise from having identical filenames in the same location, because if the method were not available, the user would need to view the contents of each file to identify the file sought.

Folders, i.e., directories, are built into the file systems of most modern computer operating systems such as Microsoft Windows, Apple MacOS, Linux, UNIX, etc.

### Tags

A tag is a keyword or term assigned to a file as a piece of descriptive metadata to aid in finding or locating the file by searching or browsing. Multiple tags can be assigned to a single file, so typically a file is tagged with a list of keywords, which is helpful since often file contents are related to multiple subjects. Tags can also take the form of name-value pairs, in which multiple field names are associated with a file, each with a value picked from an enumerated list. Yet another variation of tags is a triple tag, which consists of three parts: a namespace, a predicate and a value.

In the case of both name-value pairs and triple tags, each of the parts must be populated by the user when applying the tag, so these cannot be considered 2 and 3 level hierarchies, respectively, because in a hierarchical structure, the node can reside at any level of the hierarchical tree. Because of the lack of hierarchical structure, tags are not typically used in applications that involve well-defined, structured taxonomies where there is meaning embedded in the contextual organization of the hierarchy.

Tags are used in many modern websites such as Flickr, del.icio.us, Technorati, etc.

### Hierarchical Tags

Hierarchical tags are found in a few web-based file storage applications, which provide a tagging approach with a hierarchical tree structure. There are no known applications having a facility for associating file permissions or policies with the tags.

There are a few software products that make use of hierarchical tags, such as the ThreeTags online notebook: http://www.threetags.com.

There are also examples of hierarchical tags in current research, such as Paul Heymann at Stanford University, who is attempting in his research to create hierarchical structure from flat tags in very large datasets: http://heymann.stanford.edu/taghierarchy.html.

### Facets, Faceted Tagging, Faceted Classification and Faceted Navigation

Many popular e-commerce websites use “faceted navigation” to provide a hierarchical navigation. Using the faceted navigation approach, a large product catalog can be presented to the user in the hierarchical order that is most appropriate for what the user is seeking. In these applications, access permissions are not required, so there are no known examples of access permissions applied to facets.

Here is a product that offers a faceted navigation platform: http://facetmap.com. Contemporary research into faceted navigation includes work done at U.C. Berkeley: http://flamenco.berkeley.edu/index.html.

It would be desirable to provide a system and a process that uses a single mechanism to uniquely provide the benefits of both folders and tags.

### SUMMARY OF THE INVENTION

The present invention allows administrators of computer network-based file storage and sharing systems to use a single process to organize files into a hierarchical tree structure while providing for permissions-based access controls and file security policies. Tags are attached to files as a way of placing the file into a hierarchical structure to aid in browsing to the file, and also to provide a searchable keyword and a process for grouping similar files into appropriate classifications. Any number of tags can be assigned to each file, so that a file can be placed in multiple places in the tag hierarchy without file replication. Access permissions and document security policies are assigned on a per-tag basis and the files can inherit the permissions and policies from the file's tag(s). The invention provides a single process for organizing and permissioning files, with combined advantages of both tagging methods and traditional hierarchical folders.

In one preferred embodiment of the invention, the file sharing system for hierarchical tagging with permissions includes the following components: a hierarchical list of tags; a plurality of files; a hierarchical tag management facility; and a tag permissions facility; where each of the plurality of files may be tagged with one or more tags in the hierarchical list of tags. The hierarchical tag facility is used to create and manage the hierarchical list of tags. The tag permissions facility is activated when an administrator selects a tag. The administrator is a user having rights to facilities to configure the file sharing system. The tags permissions facility is used to change permissions to one or more users and/or groups of users to access a plurality of files tagged with the selected tag.

In another preferred embodiment of the invention, the system further includes a tags setting facility for managing settings for the selected tag.

In another preferred embodiment of the invention, the system further includes a file upload facility. The file upload facility is used for uploading one or more files to the system, where these files are contained in one or more folders. For each of the uploaded folders a hierarchical tag is created, wherein the hierarchical structure of the created tags is identical to that of the uploaded folders, and the appropriate hierarchical tags are assigned to the files contained within the corresponding folders.

In another preferred embodiment of the invention, the system further includes a user group editing facility. The user group editing facility is used for managing file security policy for a user group for each of the hierarchical list of tags.

The invention also includes a process for managing hierarchical tagging with permissions which includes the steps of: creating a hierarchical list of tags with a hierarchical tag management facility; tagging a plurality of files with one or more tags from the hierarchical list of tags; managing the hierarchical list of tags; selecting a tag by an administrator to activate a tag permissions facility; and changing permissions with the tag permissions facility to one or more groups of users to access a plurality of files tagged with the selected tag; where the administrator is a user having rights to facilities to configure the file sharing system. The process may further include steps of for defining and posting tag policies, making tag settings, and etc.

In another preferred embodiment of the invention, the process further includes the steps of: displaying a tag setting facility; and managing settings for the selected tag with the tags setting facility.

In another preferred embodiment of the invention, the process further includes the steps of: uploading one or more files to the system with a file upload facility, where the files are contained in a hierarchical structure of one or more folders; creating one or more hierarchical tags wherein the hierarchical structure of the created tags is identical to that of the uploaded folders; and assigning the appropriate hierarchical tags to the files contained the corresponding folders.

In another preferred embodiment of the invention, the process further includes the steps: managing file security policy with a user group editing facility for a user group for each of the hierarchical list of tags.

### BRIEF DESCRIPTION OF THE DRAWINGS

FIG. 1 is a schematic diagram illustrating a file sharing system for hierarchical tagging with permissions according to the invention;

FIG. 2 is a schematic diagram illustrating the tag management facility that is contained in the file sharing system according to the invention;

FIG. 3 is a schematic diagram illustrating the tag permission list component according to the invention, where the tag permission list component is a container in the tag permissions facility and the tag permission facility is contained in the file sharing system;

FIG. 4 is a schematic diagram illustrating the tag settings facility according to the invention, where the tag settings facility is contained in the file sharing system;

FIG. 5 is a screen shot illustrating a hierarchical tag management facility according to one embodiment of the invention;

FIG. 6 is a screen shot illustrating a tag permissions list component according to one embodiment of the invention;

FIG. 7 is a table illustrating the strict or lenient permissions merging rule with combination of check boxes according to one embodiment of the invention;

FIG. 8 is a screen shot illustrating the settings of the permissions and policies for a specific user group on a per-tag basis according one embodiment of the invention;

FIG. 9 is a screen shot illustrating a tag settings facility according one embodiment of the invention;

FIG. 10 is a screen shot illustrating a file uploading facility according one embodiment of the invention;

FIG. 11 is a flowchart illustrating a process for managing hierarchical tagging with permissions according to one preferred embodiment of the invention;

FIG. 12 is a flowchart illustrating a process for managing hierarchical tagging with permissions according to another preferred embodiment of the invention;

FIG. 13 is a flowchart illustrating a process for managing hierarchical tagging with permissions according to another preferred embodiment of the invention;

FIG. 14 is a flowchart illustrating a process for managing hierarchical tagging with permissions according to another preferred embodiment of the invention;

FIG. 15 is a flowchart illustrating a process for managing hierarchical tagging with permissions according to another preferred embodiment of the invention.

### DETAILED DESCRIPTION OF THE INVENTION

While the present invention may be embodied in many different forms, designs or configurations, for the purpose of promoting an understanding of the principles of the invention, reference will be made to the embodiments illustrated in the drawings and specific language will be used to describe the same. It will nevertheless be understood that no limitation of the scope of the invention is thereby intended. Any alterations and further implementations of the principles of the invention as described herein are contemplated as would normally occur to one skilled in the art to which the invention relates.

The invention allows administrators of computer network-based file storage and sharing systems to use a single process to organize files into a hierarchical tree structure while providing for permissions-based access controls and file security policies. Tags are attached to files as a way of placing the file into a hierarchical structure to aid in browsing to the file, and also to provide a searchable keyword and a process for grouping similar files into appropriate classifications. Any number of tags can be assigned to each file, so that a file can be placed in multiple places in the tag hierarchy without file replication. Access permissions and document security policies are assigned on a per-tag basis and the files can inherit the permissions and policies from the file's tag(s). The invention provides a single process for organizing and permissioning files, with combined advantages of both tagging methods and traditional hierarchical folders.

The inventive features are described in the following sections.

1. Files are organized into a hierarchical tree structure

The tags described in the invention can be organized into a hierarchical tree structure, where each node of the tree structure is a tag, with optional children sub-tags, which can in turn have optional children sub-tags, and so on. A file can be tagged with a tag from any level of this tree structure. The location of a file's tag within the tree structure provides the ability for users to locate the file based on the tag itself, and based on the hierarchical context. The hierarchical context is useful for representing structured taxonomies often required in business applications such as a due diligence lists or other ordered outlines for structuring a file index.

Tags can be created from uploaded folders. When an administrator or publisher user uploads files to the file storage system, Hierarchical tags can be created for each of the folders, assigning the tags to the files contained within the corresponding folders. A graphical user interface of the file upload facility allows the user to drag the uploaded folders onto the hierarchical tree of tags in order to create tags from the folders at the location to which the user drags.

2. Files inherit from tags the appropriate access permissions and security policies for individual users and/or groups of users with automated permissions conflict resolution

The invention provides a process for associating file access permissions and file security policies with each tag. The files tagged with a specific tag will automatically inherit these permissions and policies from the tag.

For files tagged with multiple tags having conflicting permissions the invention provides for two rules to resolve the conflict by merging the permissions: “Strict Merge” and “Lenient Merge”. For each tag, the administrator can define which of the two merge rules to use. If a user or group has been granted permission to access a file by one or more tags, and there are no “Strict Merge” tags that have been configured to deny access permission to the file, then the user or group will have the permission to access the file. In other words, the “Lenient Merge” rule allows permissions to be extended by the permission settings of other tags on that file, whereas the “Strict Merge” rule does not allow the permissions settings of other tags on the same file to extend the permissions for that file.

In one of the preferred embodiments, policies are combined by using the most conservative security attributes according to the policies that each tag has for a given user or group, however other embodiments of the invention allow the policy combination process to be based on the same “Strict” or “Lenient” rules.

In any case, the permissions and/or policies on a particular file can be “overridden” such that the file's access permissions and/or file security policies for a specific file can be customized to be different than those for the corresponding tag(s).

3. Files can be placed in multiple places within the hierarchical tree

The invention allows a specific single file to be tagged with multiple tags, allowing the file to show in multiple locations in the hierarchical tree, Frequently in applications of file sharing, a file can be related to multiple subjects as represented in the hierarchical tree, so the ability to place it in multiple locations can make it easier to find.

4. Tags are searchable and keywords can be paired with other metadata as well as with the full text of files

Tags can be searched to allow users to quickly find the files tagged with a specific tag by typing the name of the tag into a field of the search engine. Tag text can be paired with keywords within other metadata and with keywords embedded within the file itself in order to further improve the ability for a user to locate files based on keywords that appear in the tags and/or the internal text of the files themselves.

5. Files are browsed by tag filtering instead of opening folders

Unlike a normal folder-based file system, where the user can open various folders while browsing for content, the invention allows the user to instead scroll through a single continuous list of files that are filtered based on criteria such as whether the files have are tagged with one or more tags that have been selected by the user. The easy combination of selecting multiple tags to create a list of related files provides additional browsing flexibility to the user for finding the content of interest.

6. The system supports multiple sort orders

The invention provides for a display mode for browsing a list of files whereby the files are sorted according to the user's preference, such as date uploaded, date modified, alphabetic (or alphanumeric), by size, by number of pages, etc. One additional sort order is tag-based, so that the order of the files in the file list is based on the order of the tags. Within each tag, the administrator can select the sort order to show files in a preferred order within the tags, and one of the available sort orders is “custom”, which allows the administrator customize the order of the files displayed under a particular tag using drag-and-drop to reorder the file list.

7. The system provides auto-numbering for ease of tracking within the hierarchy

The invention includes an option to allow the tags to be auto-numbered to reflect the hierarchical position and order, similar to numbering within an outline. The auto-numbering facility includes a “freeze Index” mode which is typically used once the document review has begun. This mode is used by the administrator to prevent inadvertently changing the numbering, which could confuse the users. When “freeze index” mode is enabled, newly created tags can only be appended to the end of the list of tags or sub-tags, thereby preventing tag renumbering.

The invention also includes an option for the files themselves to be auto-numbered to reflect their hierarchical position and order within the tag structure. When “freeze index” mode is enabled, files are always appended to the end of the list of files under a specific tag, so that the new file does not change the numbering.

8. The system provides a hierarchical tree structure that is well-suited for business applications such as due diligence lists

One embodiment of the invention uses the hierarchical structure to represent a “due diligence list”, “due diligence index” or “due diligence questionnaire” often used in due diligence file review for mergers and acquisitions, business development transactions, business-to-business partnering, fundraising, asset sales, joint ventures. etc.

9. The system prevents filename duplicates, as an option

The invention includes an option for each tag that prevents duplicates. With this option enabled, the administrator is not allowed to have multiple files having the same name tagged with the same tag. This mimics the behavior of a folder-based approach, but it is optional, allowing the administrator to configure the desired behavior for the tag.

10. The system prevents file duplicates, as an option

The invention includes an option for each file's contents to be examined for uniqueness prior to transferring or uploading the file into the file system using a process such as a hash (MD-5 or equivalent) or the combination of the file name, file size and modification timestamp when available, or any other process for establishing a file's uniqueness. If a file is determined to be identical to a file that is already stored in the storage system, the file will not be uploaded. If the new file has tag(s) that are different than those on the existing file, the system will simply apply the new tag(s) to the existing file. There are multiple advantages to preventing the duplication of files: elimination of file upload/file transfer, reduction of storage, easier version updates and better tracking/reporting information.

11. The system allows for faceted tags for faceted navigation

The tags can be extended to allow for faceted classification, allowing the assignment of multiple tags hierarchies to an object, enabling the classifications to be ordered in multiple ways, rather than in a single, predetermined, taxonomic order. For example, a collection of books might be classified using an author facet, a subject facet, a date facet, etc. Facets can be exhaustive, in which all possible hierarchical combinations are available, or constrained or selective, in which only certain hierarchies are available. The constrained approach can be useful when the taxonomy being represented has only certain hierarchies that are well suited for faceting. Faceted classification is used in faceted search systems that enable a user to navigate information along multiple paths corresponding to different orderings of the facets. This contrasts with traditional taxonomies in which the hierarchy of categories is fixed and unchanging.

12. The system allows for tag metadata types other than the normal enumerated type

Tags that do not have sub-tags (children) are called leaf nodes because they are the extremities of the tree. In some embodiments of the invention, the leaf node tags can have metadata of a type other than an enumerated list (which would normally be the list of sub-tags or children). The metadata can be of type date, currency, floating point value, integer, percentage, etc. Some of these metadata types are continuous number types, so the filtering used to browse content with these types of tags can be based on ranges of values.

Furthermore, the invention improves upon current file tagging approaches by adding the combination of a hierarchical tree structure for the tags with tag-based permissions/policies, multiple tag-based sort orders, auto-numbering, application to representation of due diligence lists, duplicate prevention, support for faceted classification and support for multiple tag types.

The invention also improves upon current folder-based file systems by adding the ability for a single file to reside in multiple hierarchical locations, and the support for filter-based browsing and other advantages offered by tagging. Some file systems allow for “links” or “shortcuts” which allow a reference to a specific file to be placed in a different location than the original file, but this does not provide the desired automatic merging of appropriate permissions as provided for in the invention. Also, the use of tags allows the file organization/permissioning to be kept separate from the file storage.

The invention is unique because other file sharing systems organize content by using either folders or tags, or both. The invention uses a single mechanism to uniquely provide the benefits of both folders and tags in one process.

The software tools according to one embodiment of the invention are described below, including screenshots illustrating the capabilities of this embodiment.

### Hierarchical Tag Management Facility

One embodiment of the invention provides the administrator (the user(s) having the rights and facilities to configure the file sharing system, or certain: aspects of the system) with the ability to create and manage the hierarchical list of tags, including the ability to add a new tag, delete a tag, rename a tag, indent (demote in hierarchy), outdent (promote in hierarchy), move up, move down, duplicate tags and sort tags, as well as support for drag-and-drop reordering of the hierarchical tree list.

FIG. 1 is a schematic diagram illustrating a file sharing system 100 for hierarchical tagging with permissions according to one embodiment of the invention. The file sharing system for hierarchical tagging with permissions 100 includes the following: a hierarchical list of tags 110; a plurality of files 120; a hierarchical tag management facility 130; and a tag permissions facility 140. Each of the plurality of files 120 is tagged by one or more tags in the hierarchical list of tags 110. The tag management facility 130 is used to create and manage the hierarchical list of tags 110. The tag permissions facility 140 is activated when an administrator selects a tag. The administrator is a user having rights to facilities to configure the file sharing system 100. The tags permissions facility 130 is used to change permissions to one or more groups of users to access a plurality of files tagged with the selected tag.

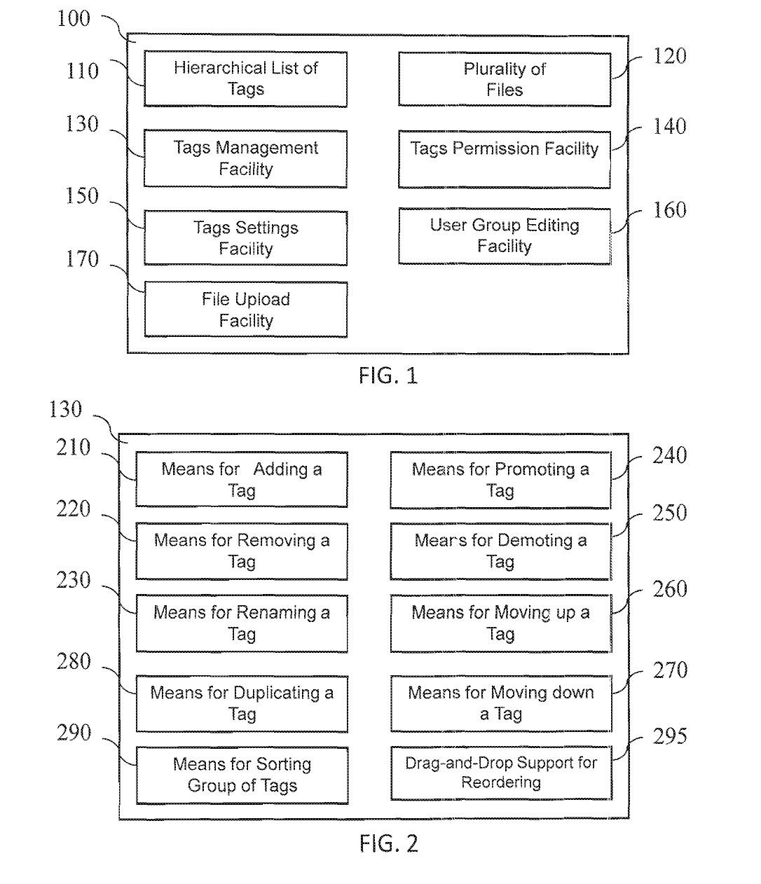

FIG. 2 is a schematic diagram illustrating the tag management facility 130 according to the invention. The tag management facility 130 includes any combination among a plurality of means. The plurality of means include: means for adding a new tag 210, means for deleting a tag 220, means for renaming a tag 230, means for promoting a tag in hierarchy 240, means for demoting a tag in hierarchy 250, means for moving up a tag 260, means for moving down a tag 270, means for duplicating a tag 280 and means for sorting group of tags 290. In another preferred embodiment, the tag management facility further includes drag-and-drop support for reordering 295. The drag-and-drop support 295 is used for reordering the hierarchical list of tags 110.

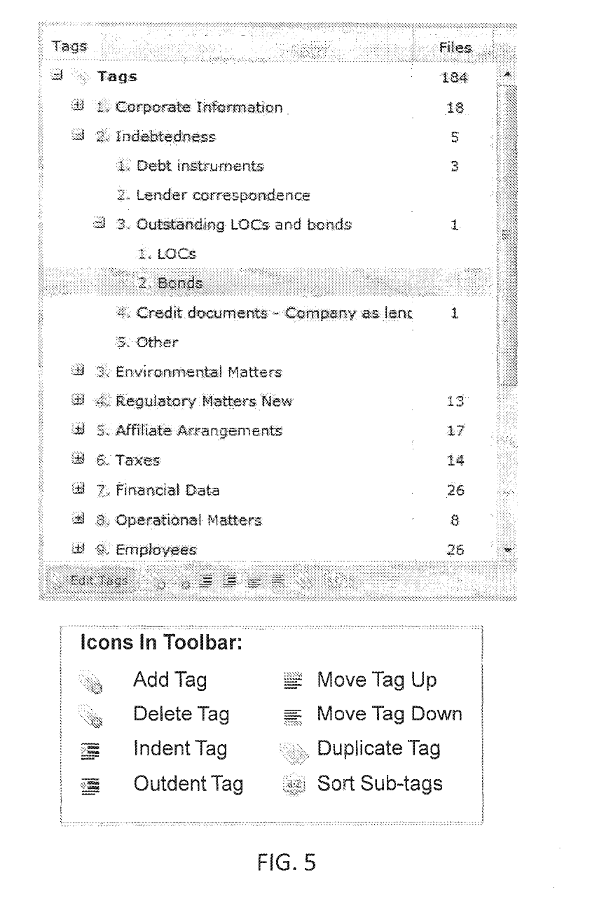

FIG. 5 is a screen shot illustrating a hierarchical tag management facility according to one embodiment of the invention. Within the tag hierarchy as illustrated in FIG. 5, a user can select a single tag, or multiple tags, and can then make charges to the permissions and/or settings as described in the following sections.

### Tag Permissions Facility

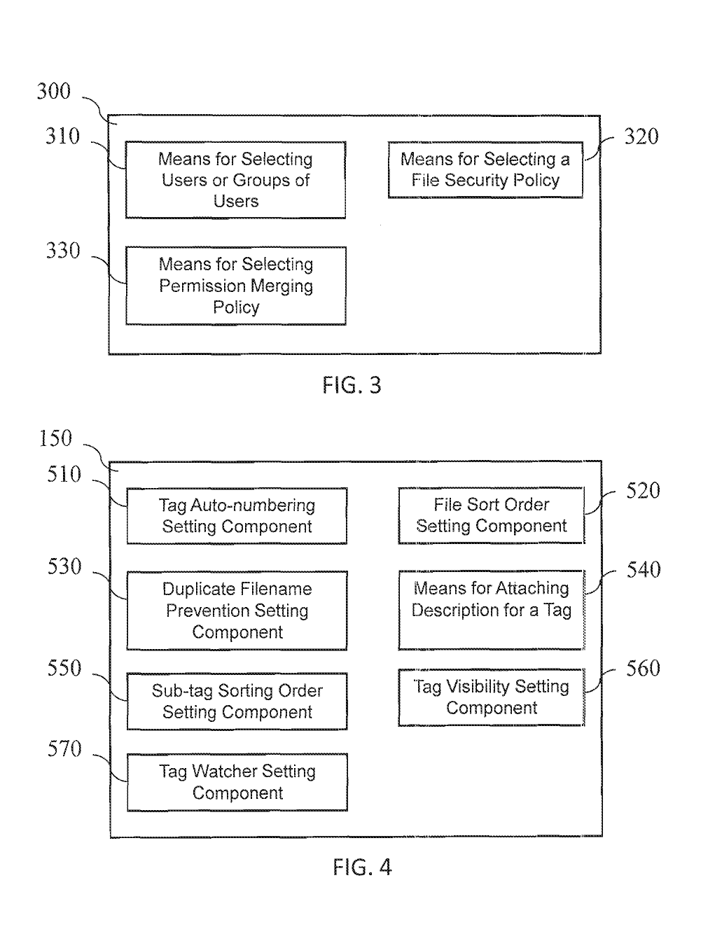

In another preferred embodiment, the tag permissions facility 140 includes a tag permissions list component. FIG. 3 is a schematic diagram illustrating the tag permission list component 300 according to one preferred embodiment of the invention. The tag permissions list component 300 includes means for selecting a group of users 310 among the one or more groups of users. By the means for selecting a group of users 310, the administrator grants access permissions to the selected users or group of users to access the plurality of files tagged with the selected tag.

In another preferred embodiment, the tag permission list component 300 further includes means for selecting a file security policy 320 among a plurality of file security policies. The means for selecting a file security policy 320 is displayed next to a group of users when the group of users is selected by the means for selecting a group of users 310. The plurality of security policies consists of a set of security attributes.

In another preferred embodiment, the tag permission list component 300 further includes a means for selecting a permission merging policy 330 among a plurality of permission merging policy. The plurality of permission merging policy includes strict and lenient rules.

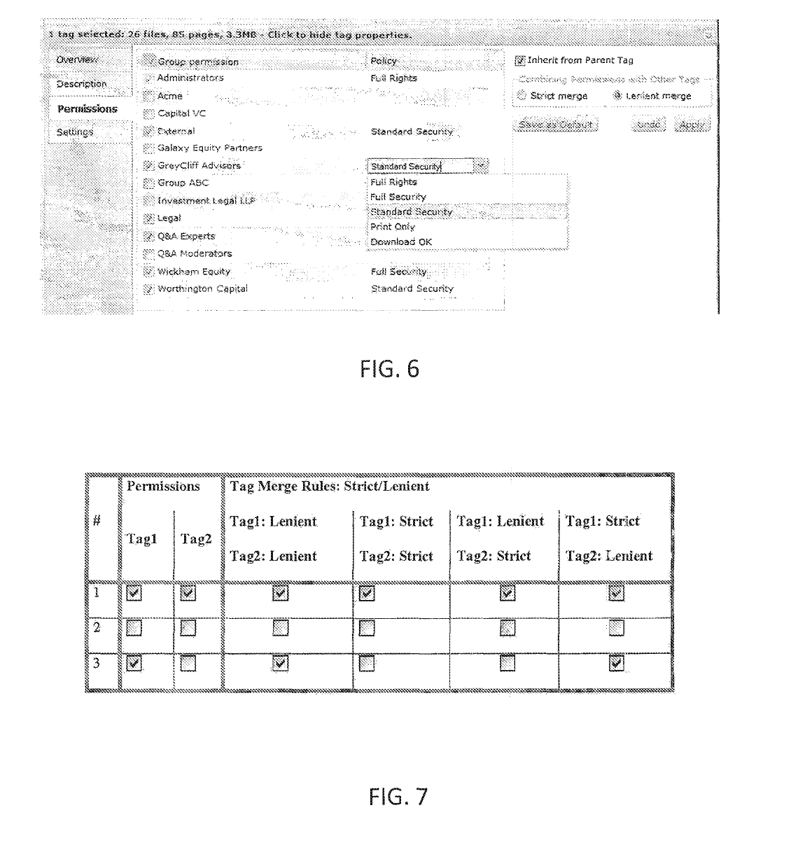

FIG. 6 is a screen shot illustrating a tag permissions list component according one embodiment of the invention. One embodiment of the invention allows the permissions of the currently selected tag to be shown in the tag permissions list, which consists of one checkbox per group, a set of pull-down menus, an “Inherent from Parent Tag” checkbox and a strict/lenient merge switch. In order to grant access permission to a group of users to access files tagged with the selected tag(s), the administrator checks the checkbox next to the group. Yet, in another embodiment of the invention, access permissions down to the user level are also supported, where the individual users are displayed beneath each user group in the list. For each user group that has been granted access permission to the selected tag, a pull-down menu is displayed next to the user group, showing the available file security policies. Each policy consists of a set of security attributes such as whether the user is allowed to print or save files tagged with the selected tag. These security attributes can also include, but not by means of limitation, whether there will be watermarks applied to the pages of the file, and if so what text and/or images should be embedded in the watermark, whether the user can capture screenshots of the file, whether text within the file can be selected/copied/pasted, the expiration date/time of the access, whether the file should be protected with digital rights management technology, and if so what type, etc., as shown in FIG. 6.

In the embodiment as illustrated in FIG. 6, the administrator can set a tag to inherit the permissions from the parent tag (the default) or select how the permissions of the current tag should be combined with those of other tag(s) in the event that a file is tagged with multiple tags, by selecting the “Strict” or “Lenient” (the default) rule for permissions merging.

A tag that has the “lenient” merge choice enabled and that is configured to deny access to a user or user group can be overridden by another tag that is configured to grant access to that same user or user group applied to the same file. The access permission for a file tagged with a “lenient” tag can therefore be extended to other groups by applying other tags.

A tag that has the “strict” merge choice enabled and that is configured to deny access to a user or user group cannot be overridden by another tag that is configured to grant access to that same user or group applied to the same file. The access permission for a file tagged with a “strict” tag cannot therefore be extended to other groups by applying other tags.

FIG. 7 is a table illustrating the strict or lenient permissions merging rules with combination of check boxes according one embodiment of the invention. For example, if the checkboxes in the second and third columns of the table of FIG. 7 represent the permissions for a specific group that has been defined for example tags Tag1 and Tag2, then the combination logic is as the following:
A. If both Tag1 and Tag2 are configured to grant access to a specific group, then a file tagged with both Tag1 and Tag2 will be accessible to this group, regardless of whether the merge rules for the tags are “strict” or “lenient”.
B. Also, if both Tag1 and Tag2 are configured to deny access to a specific group, then a file tagged with both Tag1 and Tag2 will not be accessible to this group, regardless of whether the merge rules for the tags are “strict” or “lenient”.
C. If, however, Tag1 has been configured to grant access to a specific group, and Tag2 has been configured to deny access to the same group, then the permission for that group to access a file tagged with both Tag1 and Tag2 will depend on Tag2's strict/lenient rule:
   a. If Tag2 has the “lenient” rule, then the access will be granted because Tag1 has granted access and Tag2's “lenient” rule allows the permission to be extended by another tag's permission settings.
   b. If Tag2 has the “strict” rule, then the access will be denied because Tag2's “strict” rule does not allow the permission to be extended by another tag's permission settings, even if the other tag's setting is itself “strict”.

As can be seen in the above example, the “strict”/“lenient” rule has no effect on the first two cases because there is no permissions conflict. In the third case, however, there is a conflict between the permission of Tag1 and Tag2, which is where the “strict”/“lenient” rules have their effect.

In one embodiment of the invention, the merging of the policies is done without regard to the strict/lenient merge rule, and instead uses the most conservative combination of security attributes among the merged policies. In another embodiment, the strict/lenient rule is used to determine whether policies are combined using the most conservative or the most liberal combination of each policy's security attributes.

### Tag Settings Facility

In one embodiment of the invention, the file sharing system further includes a tag settings facility 150 as illustrated in FIG. 1. FIG. 4 is a schematic diagram illustrating the tag settings facility 150 according to one embodiment of the invention. The tag settings facility 150 is used for managing settings for the selected tag.

In one embodiment of the invention, the tag settings facility 150 includes a tag auto-numbering setting component 510. The tag auto-numbering setting component 150 is used for disabling auto numbering for the selected tag and all children of the select tag. Alternatively, the tag auto-numbering setting component 150 is used for enabling auto-numbering for the selected tag and all children of the select tag with one numbering format among a plurality of numbering formats. The plurality of number formats includes any combination of the following: Arabic numbers, Latin alphabets, and Roman numbers.

In one preferred embodiment of the invention, the tag settings facility 150 includes a file sort order setting component 520. The file sort order settings component is used for selecting a file sort order among a plurality of file sort orders for the plurality of files tagged with the selected tag. The plurality of file sort orders includes any combination of custom, alphanumeric, published date and other desired order. When custom file sort order is chosen, the administrator can drag and drop a file in the plurality of files tagged by the selected tag to create desired custom order.

In one preferred embodiment of the invention, the tag settings facility 150 includes a sub-tag sort order setting component 550. The sub-tag sort order settings component 550 is used to select a sub-tag sort order among a plurality of sub-tag sort orders for sorting the child tags of the plurality of selected tag(s). The plurality of sub-tag sort orders includes any combination of custom, alphabetic, alphanumeric. With the custom sub-tag order chosen (the default), the user can drag and drop the child tags to create the desired order.

In one preferred embodiment of the invention, the tag settings facility 150 includes a tag visibility setting component 560. The tag visibility setting component is used for selecting a tag visibility setting from a plurality of tag visibility settings: “Groups with permissions to this tag”, “Groups with permission to at least 1 file” and “Administrators & Publishers only”. Selecting the “Groups with permissions to this tag” setting will result in the tag only being visible to users with permission to the tag or to users who are members of user groups with permission to the selected tag. Selecting the “Groups with permission to at least 1 file” setting will result in the tag only being visible to users with permission to at least one file tagged with the selected tag or to users who are members of user groups with permission to at least one file tagged with the selected tag. Selecting the “Administrators & Publishers only” setting will result in the tag only being visible only to users with the administrators or publishers role.

In one preferred embodiment of the invention, the tag settings facility 150 further includes a duplicate filename prevention setting component 530. The duplicate filename prevention setting component is used to prevent multiple files with the same name that are tagged with the selected tag.

In one preferred embodiment of the invention, the tag settings facility includes a tag watcher setting component 570. The tag watcher setting component 570 is used for providing special processing to be automatically performed on files as soon as they are tagged with a particular tag. These types of settings are similar to a “folder watcher” process in a folder-based file storage system, which typically applies certain file processing to file(s) as soon as they are placed in the “watched” folder.

In one preferred embodiment of the invention, the tag settings facility 150 further comprising means for attaching a description 540 to the selected tag.

FIG. 9 is a screen shot illustrating a tag settings facility according one embodiment of the invention. In FIG. 9, the Auto-numbering pull-down menu allows the user to select from “none”, which disables auto-numbering for the selected tag and all the children of the tag. Other selections enable auto-numbering for the selected tag and its children. The choices can be numbering formats such at “1. 2. 3. 4 . . . . ”, “A. B. C. D . . . . ”, “a. b. c. d . . . . ”, “I. II. III. IV . . . . ”, “i. ii. iii. iv . . . . ”, etc.

The File Sort Order can be “Custom”, “Alphanumeric”, “Date Published” or other desired sort orders as required for the application. This setting affects the sort order when the user has chosen the tag based sorting option. When custom is chosen, the administrator can drag-and-drop the files in the file list to create the desired custom order. The other sort order choices provide fixed sort orders that are easier to set-up because there is no drag-and-drop file ordering task.

The Sub-tag sort order can be “Custom” or “Alphanumeric” or other desired sort orders as required for the application. When custom is chosen, the administrator can drag and drop the child tags under the selected tag the desired custom order. When “Alphanumeric” is chosen, the child tags will be arranged in an alphanumeric order which is maintained as new child tags are added.

The “PDF Splitter” setting is an example of one type of “tag watcher” process, which, when selected, will split a PDF document assigned to the selected tag at each bookmark within the document, creating sub tags for each of the bookmarks and placing the split documents within the appropriate sub tags. Other types of tag watcher processes can be provided based on the requirements of a particular application.

The “allow duplicate filenames”, when checked, provides a way to prevent multiple files with the same name from having the same tag. This is normally a feature only provided for in folders, but in the case of folders, it is not an optional feature. Tags normally do not have this feature of preventing duplicates. When this feature is selected, if a user attempts to take an action that would result in more than one file with the same name being tagged with the same tag, and appropriate warning is displayed, and the user can choose to replace the existing file or cancel. In cases where the administrator wants to have a behavior similar to folders, then the administrator will check this checkbox. In cases where the administrator wants to have a behavior similar to standard tags, which do not prevent duplicates, this checkbox can be unchecked.

In one embodiment of the invention, the administrator can attach a description to each tag. The description allows for additional searchable text to be associated with the tag, and can be a valuable explanation to the user regarding the content tagged by the corresponding tag.

### User Group Editing Facility

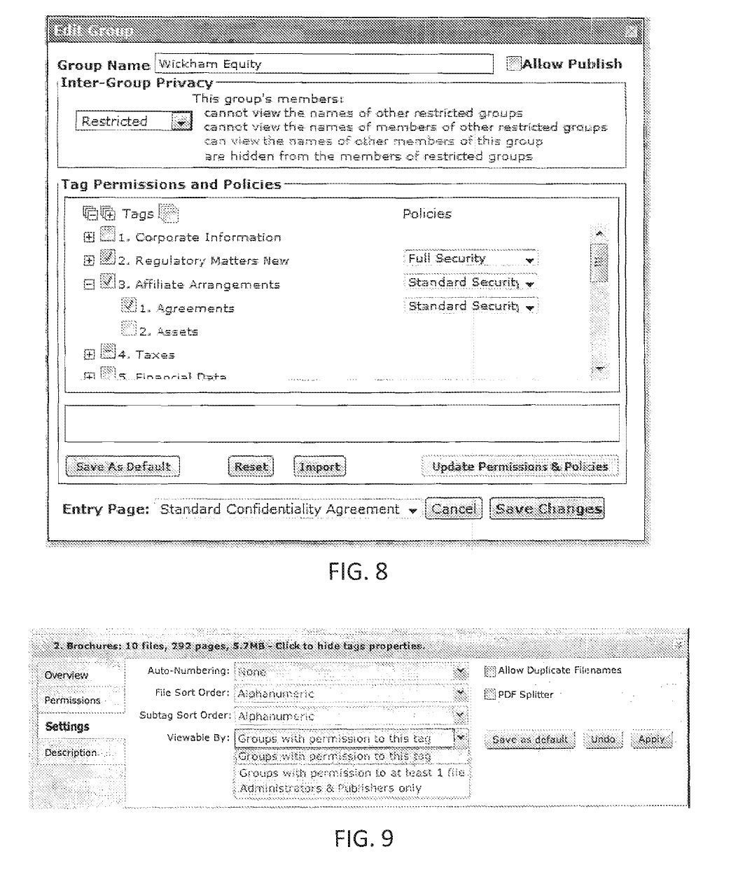

In one embodiment of the invention, the file sharing system further includes a tag settings facility 160 as illustrated in FIG. 1. The user group editing facility 160 is used for managing file security policy for a user group for each of the hierarchical list of tags.

Whereas FIG. 6 shows how a specific tag's permissions and policies can be set on a per-group basis (per-user basis can also be provided in other embodiments), there is another facility in one embodiment of the invention to set the permissions and policies for a specific user group (or specific user in other embodiments) on a per-tag basis. FIG. 8 is a screen shot illustrating the settings of the permissions and policies for a specific user group on a per-tag basis according one embodiment of the invention.

In FIG. 8, the checkboxes and pull-down menus in the scrolling list of hierarchical tags are used to grant or deny access to the current group, and to set the applicable file security policy on a per-tag basis.

### File Uploading Facility

In one embodiment of the invention, the file sharing system further includes a file upload facility 170 as illustrated in FIG. 1. The file upload facility 170 is used for uploading one or more files to the file sharing system 100. One or more files are contained in one or more folders. One or more hierarchical tags are created wherein the hierarchical structure of the created tags is identical to that of the uploaded folders, and these hierarchical tags are assigned to the appropriate files which are contained within the corresponding folders.

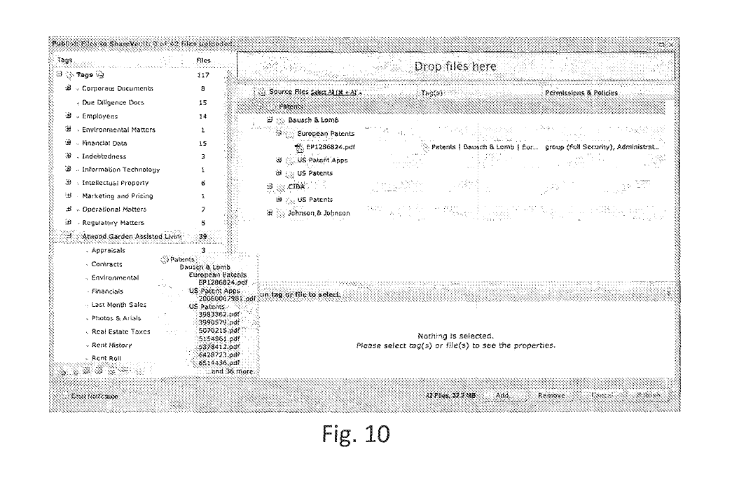

FIG. 10 is a screen shot illustrating a file uploading facility according one embodiment of the invention. When an administrator or publisher user uploads files to the file storage system, hierarchical tags can be created for each of the folders, assigning the tags to the files contained within the corresponding folders. A graphical user interface of the file upload facility allows the user to drag the uploaded folders onto the hierarchical tree of tags in order to create tags from the folders at the location to which the user drags.

Process for Managing Hierarchical Tagging with Permissions

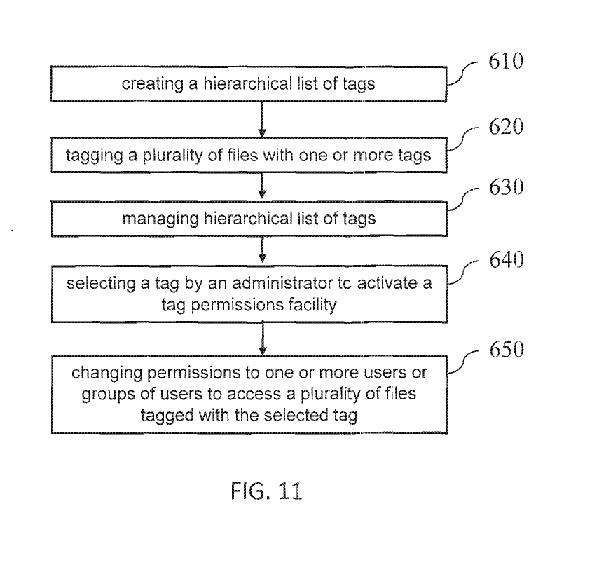

FIG. 11 is a flowchart illustrating a process for managing hierarchical tagging with permissions according to one preferred embodiment of the invention. The process for managing hierarchical tagging with permissions, comprising the following steps:

Step 610: Creating a hierarchical list of tags 110 with a hierarchical tag management facility 130;
Step 620: Tagging a plurality of files 120 with one or more tags from the hierarchical list of tags 110;
Step 630: Managing the hierarchical list of tags 110;
Step 640: Selecting a tag by an administrator to activate the tag permissions facility 140; and
Step 650: Changing permissions with the tag permissions facility 140 to one or more groups of users to access a plurality of files tagged with the selected tag. The administrator is a user having rights to facilities to configure the file sharing system 100.

In one preferred embodiment of the invention. The managing step 630 includes any combination of a plurality of actions, where the plurality of actions include: adding a new tag, deleting a tag, renaming a tag, demoting a tag in hierarchy, promoting a tag in hierarchy, moving up a tag, moving down a tag, duplicating a tag, sorting a group of tags.

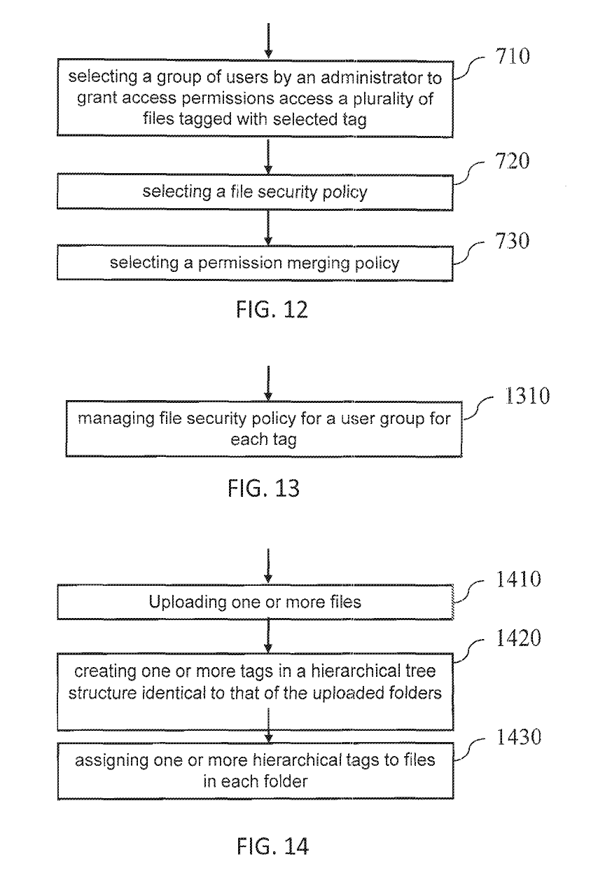

FIG. 12 is a flowchart illustrating a process for managing hierarchical tagging with permissions according to another preferred embodiment of the invention. In this preferred embodiment of the invention, the process for managing hierarchical tagging with permissions further comprising:

Step 710: Selecting a group of users by an administrator by the means of selecting a group of users 310 to grant access permissions to the group of users to access the plurality of files tagged with the selected tag.

In another preferred embodiment of the invention, the process further comprising:

Step 720: Selecting a file security policy among the plurality of file security policies by the means for selecting a file security policy 320 next to the group of users; where each of the plurality of security policies consists of a set of security attributes.

In another preferred embodiment of the invention, the process further comprising:

Step 730: Selecting a permission merging policy among a plurality of permission merging policy with the means for selecting a permission merging policy 330; where the plurality of permission merging policy include strict or lenient rules.

FIG. 13 is a flowchart illustrating a process for managing hierarchical tagging with permissions according to another preferred embodiment of the invention. In this preferred embodiment of the invention, the process for managing hierarchical tagging with permissions further comprising:

Step 1310: Managing file security policy with user group editing facility 160 for a user group for each of the hierarchical list of tags.

FIG. 14 is a flowchart illustrating a process for managing hierarchical tagging with permissions according to another preferred embodiment of the invention. In this preferred embodiment of the invention, the process for managing hierarchical tagging with permissions further comprising:

Step 1410: Uploading one or more files to the system 100 with the file upload facility 170, where the files are contained in one or more folders;
Step 1420: Creating one or more hierarchical tags wherein the hierarchical structure of the created tags matches that of the uploaded folders; and
Step 1430: Assigning the hierarchical tags to the appropriate files contained within the corresponding folders.

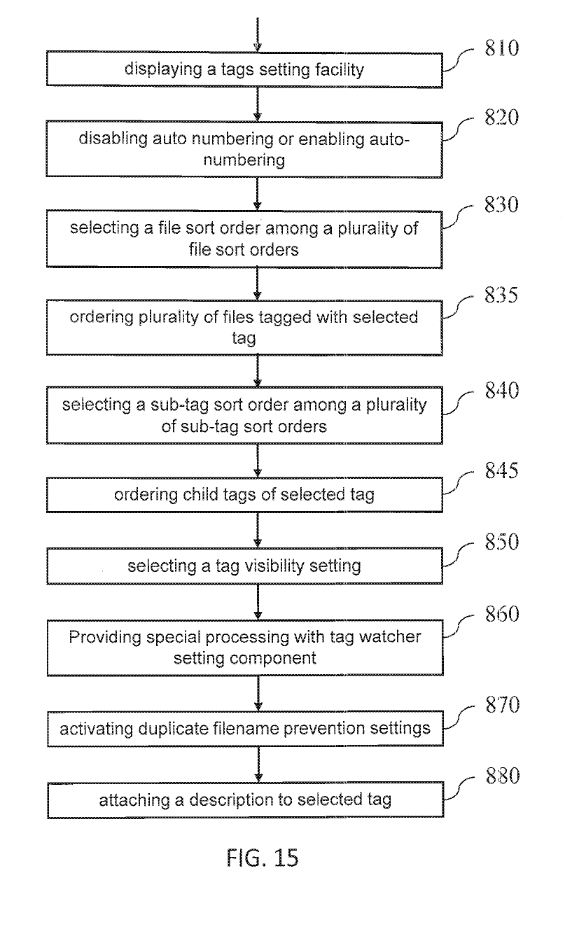

FIG. 15 is a flowchart illustrating a process for managing hierarchical tagging with permissions according to another preferred embodiment of the invention. In this preferred embodiment of the invention, the process for managing hierarchical tagging with permissions further comprising:

Step 810: Displaying a tag setting facility 150; and
Step 820: Managing settings for the selected tag with the tags setting facility 150.

In another preferred embodiment of the invention, the process further comprising:

Step 820: Disabling auto numbering with the auto-numbering settings component 510 for the selected tag and all children of the select tag, or enabling auto-numbering with the auto-numbering settings component 510 for the selected tag and all children of the select tag with a numbering format among a plurality of numbering formats. The plurality of number formats includes any combination of Arabic numbers, Latin alphabets, and Roman numbers.

In another preferred embodiment of the invention, the process further comprising:

Step 830: Selecting a file sort order among a plurality of file sort orders with the file sort order setting component 520;
Step 835: Ordering the plurality of files tagged with the selected tag according to the selected file sort order. The plurality of file sort orders includes any combination of custom, alphanumeric, published date or other desired order. When custom file sort order is chosen, the administrator can drag and drop a file in the plurality of files that are tagged by the selected tag to create desired custom order.

In another preferred embodiment of the invention, the process further comprising:

Step 840: Selecting a sub-tag sort order among a plurality of sub-tag sort orders with the sub-tag sort order setting component 550;
Step 845: Ordering the plurality of child tags of the selected tag according to the selected sub-tag sort order. The plurality of sub-tag sort orders includes any combination of custom, alphanumeric, or other desired order. When custom sort order is chosen, the administrator can drag and drop child tags of the selected tag to create desired custom order.

In another preferred embodiment of the invention, the process further comprising:

Step 850: Selecting a tag visibility setting from a plurality of tag visibility setting with the tag visibility setting component 560. The plurality of tag visibility setting includes any combination of: groups with permissions to the selected tag, groups with permission to at least one file which is tagged with the selected tag and administrators and publishers only.

In another preferred embodiment of the invention, the process further comprising:

Step 860: Providing special processing with the tag watcher setting component 570 to be automatically performed on one or more files as soon as these files are tagged with the selected tag.

In another preferred embodiment of the invention, the process further comprising:

Step 870: Activating duplicate filename prevention setting with the duplicate prevention setting component 530 to prevent multiple files with the same name which tagged with the selected tag.

In another preferred embodiment of the invention, the process further comprising:

Step 880: Attaching a description to the selected tag with the attaching means 540.

Advantages of the invention over known systems are numerous. Here are just few examples:
1) Provides a single method for organizing and managing the permissions of files that combines the advantages of traditional hierarchical folders with those of tagging.
2) Unlike folders, the invention allows files to be located in multiple places in the hierarchy, without the need for introducing shortcuts, which can be confusing for users due to needing to keep track of the one location where the original is kept, while also needing to keep track of the shortcuts to refer to a file before deleting or moving the file
3) Unlike folders, the invention keeps the hierarchical organization separate from the file storage, so that if tag is deleted, the files are not deleted, and can continue to be referenced by other tags. A folder, on the other hand, can only be deleted by also deleting the contained file(s).
4) Unlike folders, provides for a more flexible file browsing metaphor based on tag filtering according to the information sought, rather than opening multiple folders to “hunt the hierarchy” for the files of interest.
5) Unlike folders, can be easily extended to support faceted tagging/faceted classification.
6) Unlike folders, can be easily extended to provide metadata types on the leaf node tags other than enumerated types, such as date, currency, floating point number, integer, string, etc. . . .
7) Unlike traditional tags, the invention allows for a hierarchical tree structure while also allowing files to inherit permissions and/or security policies from the tag(s) associated with the file. The invention also provides a simple method to merge conflicting permissions and/or policies from multiple tags, via the strict/lenient rules.
8) Unlike traditional tags, provides for an optional “prevent duplicates” switch, which, when enabled, provides a similar duplicate filename prevention logic as a folder-based approach.
9) Provides for multiple sort orders so that content can be presented in the order desired by the administrator by default, while allowing the end user to change the sort order to suit the individual's requirement.
10) Provides for an optional hierarchical numbering schema, which can further aid in the navigation of structured hierarchical content.

While one or more embodiments of the present invention have been illustrated above, the skilled artisan will appreciate that modifications and adoptions to those embodiments may be made without departing from the scope and spirit of the present invention.

What is claimed is:

1. A file sharing system for hierarchical tagging with permissions, comprising: a hierarchical list of tags; a plurality of files; a hierarchical tag management facility; and a tag permissions facility; wherein each of said plurality of files is tagged by one or more tags in said hierarchical list of tags; wherein said hierarchical tag facility is used to create and manage said hierarchical list of tags; wherein said tag permissions facility is activated when an administrator selects a tag; wherein said administrator is a user having rights to facilities to configure said file sharing system; and wherein said tags permissions facility is used to change permissions to one or more groups of users to access one or more files tagged with said selected.

2. The file sharing system of claim 1, wherein said tag management facility comprises any combination among a plurality of means; said plurality of means include: means for adding a new tag, means for deleting a tag, means for renaming a tag, means for demoting a tag in hierarchy, means for promoting a tag in hierarchy, means for moving up a tag, means for moving down a tag, means for duplicating a tag and means for sorting groups of tags by a variety of sort criteria.

3. The file sharing system of claim 1, wherein said tag management facility further comprises drag-and-drop support for reordering of said hierarchical list of tags.

4. The file sharing system of claim 1, wherein said tag permissions facility comprises a tag permissions list component; wherein said tag permissions list component comprises means for selecting one or more users or groups of users among said one or more users or groups of users; wherein said administrator grants access permissions by said means for selecting a group of users to said group of users to access said one or more files tagged with said selected.

5. The file sharing system of claim 4, wherein said tag permission list component further comprises means for selecting a file security policy among a plurality of file security policies; wherein said means for selecting a file security policy is displayed next to said group of users when said group of users is selected by said means for selecting a group of users; wherein each of said plurality of security policies consists of a set of security attributes.

6. The file sharing system of claim 5, wherein said tags permissions list component further comprises a means for selecting a permission merging policy among plurality of permission merging policy; wherein said plurality of permission merging policy include strict and lenient rules.

7. The file sharing system of claim 4, wherein said tag permission list component further comprises means for selecting a group and selecting tags and sub-tags to which said selected group has access.

8. The file sharing system of claim 1, wherein said system further comprises a tag settings facility for managing settings for said selected tag.

9. The file sharing system of claim 8, wherein said tag settings facility comprises a tag auto-numbering setting component; wherein said tag auto-numbering setting component is used for disabling auto numbering for said selected tag and all children of said select tag, or enabling auto-numbering for said selected tag and all children of said select tag with one numbering format among a plurality of numbering formats; said plurality of number formats includes any combination of Arabic numbers, Latin alphabets, and Roman numbers.

10. The system of claim 8, wherein said tag settings facility comprises a file sort order setting component; wherein said file sort order settings component is used for selecting a file sort order among a plurality of file sort orders for said one or more files tagged with said selected tag; said plurality of file sort orders includes any combination of custom, alphanumeric, published date or other desired order, wherein when custom file sort order is chosen, said administrator can drag and drop a file in said one or more files tagged by said selected tag to create desired custom order.

11. The system of claim 8, wherein said tag settings facility further comprises a duplicate filename prevention setting component; wherein said duplicate filename prevention setting component is used to prevent multiple files with the same name which are tagged with said selected tag.

12. The system of claim 8, wherein said tag settings facility further comprising means for attaching a description to said selected tag.

13. The system of claim 8, wherein said tag settings facility comprises a sub-tag sort order setting component; wherein said sub-tag sort order settings component is used for selecting a sub-tag sort order among a plurality of sub-tag sort orders for sorting child tags of said selected tag; said plurality of sub-tag sort orders includes any combination of custom, alphanumeric or other desired order; wherein when custom sort order is chosen, said administrator can drag and drop said child tags to create desired custom order.

14. The system of claim 8, wherein said tag settings facility comprises a tag visibility setting component; wherein said tag visibility setting component is used for selecting one from a plurality of tag visibility settings; said plurality of tag visibility setting includes any combination of groups with permissions to said selected tag, groups with permission to at least one file which is tagged with said selected tag and administrators and publishers only.

15. The system of claim 8, wherein said tag settings facility further comprises a tag watcher setting component; wherein said tag watcher setting component is used for providing special processing to be automatically performed on one or more files as soon as said one or more files are tagged with said selected tag.

16. The system of claim 1, wherein said system further comprising a file upload facility, said file upload facility is used for uploading one or more files to said system, said one or more files are contained in a hierarchical structure of one or more folders, hierarchical tags are created for each of said one or more folders, wherein the hierarchical structure of the created tags is identical to that of the said folders, and said hierarchical tags are assigned to said one or more files contained within said each of said one or more folders

17. The system of claim 1, wherein said system further comprising a user group editing facility, said user group editing facility is used for managing file security policy for a user group for each of said hierarchical list of tags.

18. A process for managing hierarchical tagging with permissions, comprising the steps of: creating a hierarchical list of tags with a hierarchical tag management facility; tagging a plurality of files with one or more tags from said hierarchical list of tags; managing said hierarchical list of tags; selecting a tag by an administrator to active a tag permissions facility; and changing permissions with said tag permissions facility to one or more groups of users to access one or more files tagged with said selected tag; wherein said administrator is a user having rights to facilities to configure said file sharing system.

19. The process of claim 18, wherein said step of managing said hierarchical list of tags includes any combination of a plurality of actions, said plurality of actions include: adding a new tag, deleting a tag, renaming a tag, demoting a tag in hierarchy, promoting a tag in hierarchy, moving up a tag, moving down a tag, duplicating a tag and sorting a group of tags.

20. The process of claim 18, wherein said tag management facility further comprising drag-and-drop support for reordering of said hierarchical list of tags.

21. The process of claim 17, wherein said tag permissions facility comprises a tag permissions list component; said tag permissions list component comprising means to select one group of users among said one or more groups of users; said process further comprising: selecting a group of users by an administrator by said means of selecting a group of users to grant access permissions to said group of users to access said one or more files tagged with said selected tag.

22. The process of claim 21, wherein said tag permissions list component further comprises a means for selecting a file security policy among a plurality of file security policies, wherein said means for selecting a file security policy is displayed next to said group of users when said group of users is selected by said means for selecting a group of users; said process further comprising: selecting a file security policy among said plurality of file security policies by said means for selecting a file security policy next to said group of users; wherein each of said plurality of security policies consists of a set of security attributes.

23. The process of claim 21, wherein said tags permissions list component further comprises a means for selecting a permission merging policy, said process further comprising: selecting a permission merging policy among a plurality of permission merging policy with said means for selecting a permission merging policy; wherein said plurality of permission merging policy include strict or lenient rules.

24. The process of claim 18, further comprising: displaying a tag setting facility; and managing settings for said selected tag with said tags setting facility.

25. The process of claim 24, wherein said tag settings facility comprises a auto-numbering settings component; said process further comprising: disabling auto numbering with said auto-numbering settings component for said selected tag and all children of said select tag, or enabling auto-numbering with said auto-numbering settings component for said selected tag and all children of said select tag with a numbering format among a plurality of numbering formats; wherein said plurality of number formats includes any combination of Arabic numbers, Latin alphabets, and Roman numbers.

26. The process of claim 24, wherein said tag settings facility comprises a file sort order setting component; said process further comprising: selecting a file sort order among a plurality of file sort orders with said file sort order setting component; and ordering said one or more files tagged with said selected tag according to said selected file sort order; wherein said plurality of file sort orders includes any combination of custom, alphanumeric, published date or other desired order; wherein when custom file sort order is chosen, said administrator can drag and drop a file in said one or more files which are tagged by said selected tag to create desired custom order

27. The process of claim 24, wherein said tag settings facility comprises a duplicate filename prevention setting component; said process further comprising: activating duplicate filename prevention setting with said duplicate prevention setting component to prevent multiple files with the same name which are tagged with said selected tag.

28. The process of claim 24, wherein said tags settings component further comprises a means for attaching a description for said selected tag; said process further comprising: attaching a description to said selected tag with said attaching means.

29. The process of claim 28, further comprising: setting tag visibility, choosing sub-tag sorting, and setting tag watcher.

30. The process of claim 24, wherein said tag settings facility comprises a sub-tag sort order setting component; said process further comprising: selecting a sub-tag sort order among a plurality of sub-tag sort orders with said file sort order setting component; and ordering child tags of said selected tag according to said selected sub-tag sort order; wherein said plurality of sub-tag sort orders includes any combination of custom, alphanumeric or other desired order; wherein when custom sort order is chosen, said administrator can drag and drop said child tags to create desired custom order.

31. The process of claim 24, wherein said tag settings facility comprises a tag visibility setting component; said process further comprising: selecting a tag visibility setting from a plurality of tag visibility setting with said tag visibility setting component; said plurality of tag visibility setting includes any combination of groups with permissions to said selected tag, groups with permission to at least one file which is tagged with said selected tag and administrators and publishers only.

32. The process of claim 24, wherein said tag settings facility further comprises a tag watcher setting component; wherein said process further comprising: providing special processing with said tag watcher setting component to be automatically performed on one or more files as soon as said one or more files are tagged with said selected tag.

33. The process of claim 18, wherein said system further comprising a file upload facility, said process further comprising: uploading one or more files to said system with said file upload facility, said one or more files are contained in a hierarchical structure of one or more folders; creating one or more hierarchical tags, wherein the hierarchical structure of the created tags is identical to that of the uploaded folders; and assigning said one or more hierarchical tags to said one or more files contained within said each of said one or more folders.

34. The process of claim 18, wherein said system further comprising a user group editing facility, said process further comprising: managing file security policy with said user group editing facility for a user group for each of said hierarchical list of tags.
